(19) United States
(12) Patent Application Publication
(10) Pub. No.: US 2018/0312264 A1
(43) Pub. Date: Nov. 1, 2018

(54) PACKAGING FOR A PARACHUTE

(71) Applicant: Strategic Support Limited, Aylesford Kent (GB)

(72) Inventors: George Michael COOK, Maidstone Kent (GB); Jonathan COOK, Faversham Kent (GB); Michael COOK, Chatham Kent (GB)

(73) Assignees: Strategic Support Limited, Aylesford Kent (GB); Strategic Support Limited, Aylesford Kent (GB)

(21) Appl. No.: 15/527,912

(22) PCT Filed: Nov. 17, 2015
(86) PCT No.: PCT/GB2015/053481

§ 371 Date: May 18, 2017

(30) Foreign Application Priority Data
Nov. 20, 2014 (GB) 1420650.2

(51) Int. Cl. B64D 17/60; B64D 17/50

(52) U.S. Cl. CPC B64D 17/60; B64D 1/08; B64D 17/50

(57) ABSTRACT

A parachute arrangement comprising a parachute having a canopy, a plurality of shroud lines coupled to the canopy, and a plurality of connectors (23) coupled to the shroud lines for attachment to a load; and a packaging (10) for the parachute, the packaging comprising an enclosure formed of a web material, wherein each of the shroud lines and/or connectors is engaged with the enclosure to thereby maintain the connectors in a spaced-apart arrangement for attachment to the load.

### FIELD OF THE INVENTION

The invention relates to the field of a packaging for a parachute, in particular a single-use packaging for a parachute.

### BACKGROUND OF THE INVENTION

Conventional aerial delivery systems have been developed to allow goods and personnel to be delivered to inaccessible or hard-to-reach locations. For example, emergency relief can quickly be delivered to regions which are cut off from usual delivery routes and supplies can be safely delivered to bases in hostile environments. Aerial delivery is advantageous because it allows these deliveries to be made with the minimum of risk and aerial delivery is often the fastest way of delivering goods to these areas.

Conventional aerial delivery systems generally comprise a platform, onto which the goods are secured, or a box, which is coupled to a parachute. The box or platform will then be dropped at a height from an aeroplane or helicopter above a target location, with the parachute slowing the descent of the package. The goods can subsequently be recovered at the target location.

Alternatively, due to high costs associated with the use of parachutes and difficulties in recovering parachutes, goods may be dropped without a parachute, using free drop methods. There are inevitable risks that the goods being delivered will be damaged or persons at the point of impact will be injured.

In conventional aerial delivery systems, the parachute is typically contained within a package, such as a rucksack or a parachute bag. The parachute can then be removed from the package and secured to the load via the parachute's shroud lines (otherwise known as suspension lines). While this may avoid the need for the parachute to be precisely packaged in the packaging, it requires assembly and an operator with the correct skills and expertise at the point of use. As such, this is inefficient in large scale operations, or where the required expertise is not available. Due to the inherent risks associated with using a loose parachute, such as the unfolding of the parachute, the time between assembling the delivery system and the time in which the system is released from height should be as small as possible. This too causes inefficiencies and limits the volume of cargo that can be delivered.

Alternatively, some aerial delivery systems use an arrangement whereby the shroud lines of the parachute are secured to the packaging and the packaging will be secured to the goods or the personnel that are being released. In this arrangement, the packaging forms a part of the harness and therefore must be suitably strong to support the weight of the goods and the forces involved in the deployment and use of the parachute. In many cases, aerial delivery systems are only used once as the recovery of parachutes and packaging can be too expensive or too dangerous to make recovery viable. Furthermore the use of such systems can have a substantial environmental impact as significant resources are not recovered or re-used and can damage or blight the environment. For example, the majority of parachutes are manufactured from nylon and the boxes or packaging in an aerial delivery system from plastic, wood or metal and, therefore, could be re-used multiple times if recovered.

### SUMMARY OF THE INVENTION

According to the invention, there is provided a disposable packaging and a parachute arrangement as defined in the independent claims.

A first aspect of the invention provides a parachute arrangement comprising a parachute having a canopy, a plurality of shroud lines coupled to the canopy, and at least one connector coupled to the shroud lines for attachment to a load and packaging for the parachute, the packaging comprising an enclosure formed of a web material, wherein each of the shroud lines and/or the at least one connector is engaged with the enclosure to thereby maintain the at least one connector in a predetermined arrangement for attachment to the load.

Embodiments may therefore provide an assembly including a container holding a pre-folded parachute that maintains the shroud lines and./or at least one connector of the parachute in a position where the shroud lines are prevented from becoming tangled and the at least one connector can easily be accessed so as to facilitate the attachment of the parachute to a load to be delivered. (Embodiments may also therefore hold the shroud lines in (a) position(s) in which they are prevented from becoming tangled and can easily be accessed). It may allow a user to easily connect the parachute directly to the load without removing the pre-folded parachute from the packaging. Not only does this speed up the process of attaching the parachute to the load and lower the level of training required for the user, but this also lowers the risk of the parachute becoming tangled or unfolded, for example compared to means of connecting parachutes that involve unpacking the parachute.

In other words, the connectors are maintained in a predetermined deployment configuration, in which the at least one connector and/or the plurality of shroud lines are held in a predetermined arrangement and/or are maintained in an arrangement relative to one another such that the parachute may deploy correctly or tangling of the shroud lines is reduced or prevented and the shroud lines can be attached to the load via the at least one connector without removal of the parachute from the packaging. Thus, the shroud lines and/or the at least one connector may be maintained in an arrangement in which the positions of the at least one connector and, in embodiments, the shroud lines, are held relative to each other, which may prevent the shroud lines from crossing over each other. In this way the at least one connector and, in embodiments, shroud lines may be presented in an arrangement to the user such that they can easily be attached to a load in a correct manner.

Web material includes, but is not limited to, the following materials: cellulose-based materials such as paper, card, cardboard or any other woodpulp material; fabrics such as linen; nylon; cotton; plastics; biodegradable plastics (e.g. Polylactic acid); any woven materials, non-woven materials, sheets of materials, materials with net structures and film materials, for example.

In an embodiment, the packaging is structurally independent of the parachute.

Embodiments therefore provide a parachute arrangement in which a packaging is provided to facilitate attachment of the parachute to the packaging, but does not form part of the parachute itself. Thus, as the parachute is deployed, the packaging can be separated from the parachute.

By predetermined, it is meant that the at least one connector and/or the shroud lines have been deliberately engaged with the packaging in a particular arrangement. In other words, the at least one connector and/or the shroud lines have been engaged with the packaging so as to hold the at least one connector and/or shroud lines in a configuration relative to one another and relative to the packaging. This can require that the packaging has been designed to facilitate or require this particular configuration or arrangement.

This arrangement means that, as the parachute directly attaches to the load, rather than through the packaging, the strength of the materials used in the packaging can be reduced and the cost of producing the packaging can be reduced. Moreover, the burden of strength or safety testing of the materials of the packaging is greatly reduced, since the packaging does not need to support the load. This drastically reduces the cost of the packaging, while improving the safety aspects of the installation of the parachute. This also reduces the number of connections that could wear and therefore must be checked between the parachute and the load, compared to a parachute that is connected to a load via the packaging.

Cost may be further reduced as the requirement for specialist equipment to attach the packaging to the load, or to remove the parachute from the packaging prior to attachment can be eliminated or reduced.

By structurally independent, it is meant that the packaging does not form part of the structure of the shroud lines, connectors or canopy of the parachute. In other words, it is not an integral part of the parachute and does not provide any load-bearing connection between the load and the canopy of the parachute. Thus, the packaging can be discarded during deployment of the parachute, or may alternatively remain attached to part of the parachute as the load is delivered, but it does not form part an integral part of the connection between the load and the parachute. It will be appreciated that this does not exclude the parachute and the packaging being connected together, for example, by stitching, since this does not provide load-bearing capacity and this is required by the engagement of the at least one connector and/or shroud lines to the packaging.

In another embodiment, the parachute comprises a plurality of connectors and each of the connectors is maintained in a spaced-apart arrangement for attachment to the load.

In another embodiment, the engagement between the shroud lines and/or the connector and the enclosure comprises an adhesive attachment. In a further embodiment, the engagement between the shroud lines and/or the connector and the enclosure comprises a mechanical connection, such as stitching. Preferably, the connection is a frangible or releasable connection. Accordingly, the plurality of shroud lines and/or connectors are held in a predetermined arrangement which enables the correct deployment of the parachute from the packaging. Further, holding the shroud lines and/or connectors will reduce the risk of the shroud lines moving or tangling.

In yet a further embodiment, the engagement between the shroud lines and/or the connector and the enclosure comprises the connector, and optionally the shroud lines, extending through an aperture formed in the enclosure.

In yet a further embodiment, the enclosure is adapted to conceal the connectors; and the packaging further comprises means for tearing the web material of the enclosure in a predetermined pattern to expose the connectors for attachment to the load. In this embodiment, the risk of damage to the shroud lines is reduced as the shroud lines are not fully exposed by the packaging until the user is attaching the parachute to the load to be delivered. Optionally, the packaging is adapted to entirely conceal the plurality of shroud lines. In a further embodiment, the predetermined pattern defines a plurality of flaps of web material, each flap for exposing a respective different connector.

In a further embodiment, each shroud line and/or connector is engaged with the inside surface of one of the plurality of flaps.

In a further embodiment, the means for tearing comprises a linear weakness in the web material, such as a line of perforations. This enables a user to easily and quickly access the shroud lines.

In a further embodiment, the parachute further comprises a deployment line coupled to the canopy, optionally provided with a drogue parachute. In a further embodiment, the deployment line is engaged with the enclosure to thereby maintain the deployment line spaced-apart from the at least one connector. The parachute may also further comprise a means for slowing the deployment of the parachute when it is extracted from the packaging and/or snatch force mitigation means. Optionally, the means for slowing the deployment of the parachute is a slider.

In a further embodiment, the means for tearing comprises the deployment line being adapted to tear the web material in the predetermined pattern when it is pulled. In a further embodiment, the enclosure further comprises additional weaknesses in the web material adapted to facilitate extraction of the parachute from the enclosure during deployment.

In a further embodiment, the web material is adapted to tear upon deployment of the parachute in static conditions with a 5 kg load.

In a further embodiment, the at least one connector is extended from the shroud lines, and optionally comprises loops.

In a further embodiment, the enclosure comprises an outer housing and an inner housing housed within the outer housing and the canopy of the parachute is contained within the inner housing and the at least one connector, and optionally the shroud lines, of the parachute extend from the inner housing into the outer housing.

In a further embodiment, the packaging is formed of a biodegradable material, optionally the packaging consists essentially of a biodegradable material. In other words, the web material is a biodegradable material. For example, the biodegradable material may be paper, cardboard or any other woodpulp material; cotton; biodegradable plastic (e.g. Polylactic acid); or any other biodegradable material. By biodegradable, it is meant that materials can be decomposed by microorganisms, in particular by bacteria. The invention in this aspect provides an inexpensive and lightweight packaging providing means for containing and protecting a parachute with a low environmental impact. Accordingly, the packaging will not damage the environment, nor will it be an unnecessary waste of resources, as the packaging is single-use. Moreover, in an embodiment, the packaging can be manufactured from recycled materials thereby reducing the impact further. In addition, in another embodiment the materials involved can be inexpensive and delivery can be achieved for significantly less. Further features may also be included, such as covering the packaging in a waterproofing material to protect the packaging and the parachute therein. In embodiments, the waterproofing material can be a wax, in particular a clean-burning wax or a polymer coating of nano-scale thickness, allowing the packaging to be safely burned. The term “nano-scale thickness” means a thickness of 1 nm to 10000 nm, preferably 1 nm to 1000 nm thick, more preferably 1 nm to 500 nm thick. For example, the polymer coating may be a hydrophobic polymer coating such as ethylcellulose.

The term “consists essentially of . . . ” means that the packaging is almost entirely formed from a biodegradable material, but may contain minor quantities of other materials. For example, it may be formed from 85% or greater biodegradable materials (by weight or by volume), preferably 90% or greater, more preferably 95% or greater or even more preferably 99% or greater biodegradable materials.

In a further embodiment, the parachute is formed of a biodegradable material. For example, the shroud lines and the canopy may be biodegradeable. The parachute therefore has a low environmental impact when used. In an embodiment, the parachute may also be safely combustible or recyclable. Optionally, the parachute consists essentially of a biodegradable material. The term “consists essentially of . . . ” means that the parachute is almost entirely formed from a biodegradable material, but may contain minor quantities of other materials. For example, it may be formed from 75% or greater biodegradable materials (by weight or by volume), preferably 85% or greater, more preferably 90% or 95% or greater or even more preferably 99% or greater biodegradable materials.

In a further embodiment, the parachute further comprises a parachute release mechanism for releasing the parachute from the load upon delivery of the load. For example, the parachute may comprise a mechanism to release or automatically sever the connection between the parachute and the load after the load has been delivered, so as to facilitate removal of the parachute from the load, and reduce the risk of the parachute dragging and damaging the load once it has been delivered. Examples of such mechanisms use explosive decoupling, which can sever the connection between the load and the connectors, or between the connectors and the shroud lines, for example. Other mechanisms include cutting blades or hook release systems, for example.

In a second aspect of the invention, a parachute packaging for a parachute is provided, the packaging comprising a canopy, a plurality of shroud lines coupled to the canopy, and at least one connector coupled to the shroud lines for attachment to a load, the packaging comprising an enclosure formed of a web material, the enclosure being adapted to engage each of the shroud lines and/or the at least one connector to thereby maintain the at least one connector in a predetermined arrangement for attachment to the load.

In an embodiment, the packaging is a disposable packaging.

### BRIEF DESCRIPTION OF THE DRAWINGS

Specific embodiments of the invention will now be discussed in detail with reference to the accompanying drawings, in which:

FIG. 1 shows a perspective view of an embodiment of the present invention;

FIG. 2 shows a perspective view of an embodiment of the present invention;

FIG. 3 shows a perspective view of an embodiment of the present invention prior to release from an aircraft;

FIG. 4 shows a perspective view of an embodiment of the present invention as it is released from an aircraft;

FIG. 5 shows an exploded view of an embodiment of the present invention.

FIG. 6 shows a perspective view of an embodiment of the present invention;

FIG. 7 shows a perspective view of an embodiment of the present invention;

FIG. 8 shows a perspective view of an embodiment of the present invention;

FIG. 9 shows a perspective view of an embodiment of the present invention attached to a load;

FIG. 10 shows a perspective view of an embodiment of the present invention as it is released from an aircraft;

FIG. 11 shows a perspective view of an embodiment of the present invention; and

FIG. 12 shows a perspective view of an embodiment of the present invention.

### DETAILED DESCRIPTION

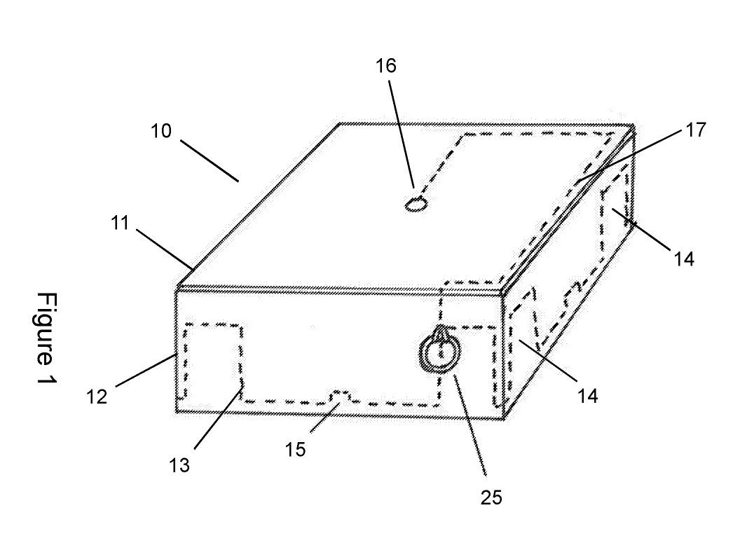

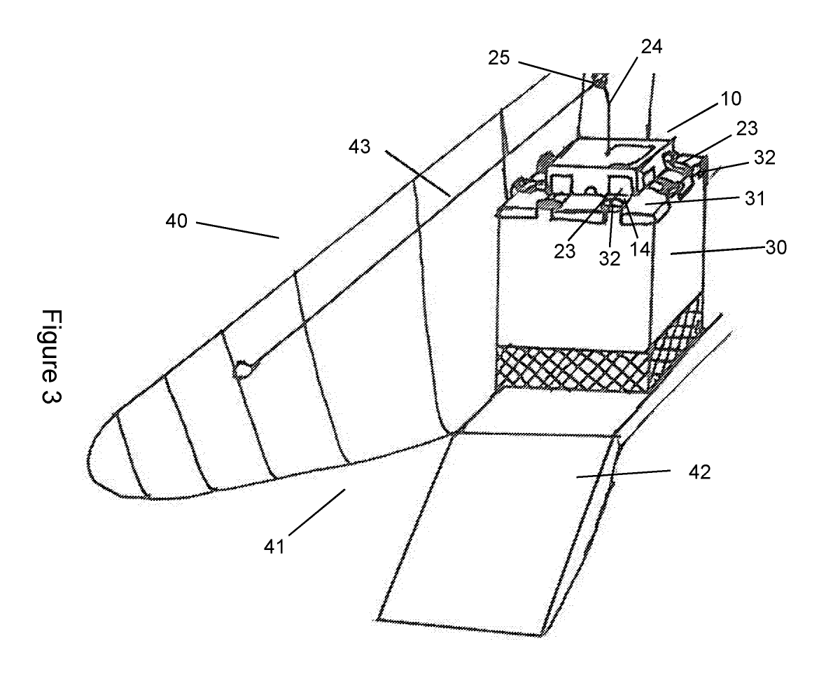

A first embodiment of the invention is shown in FIGS. 1 to 4. The packaging 10 comprises an inner box 11 located in an outer tray 12. In this embodiment, both the inner box 11 and the outer tray 12 are formed of biodegradable cardboard, such that the packaging can be produced at very little cost and with very little environmental impact. The packaging 10 is adapted to enable the straightforward attachment of a parachute 20 to a load 30 (FIG. 3).

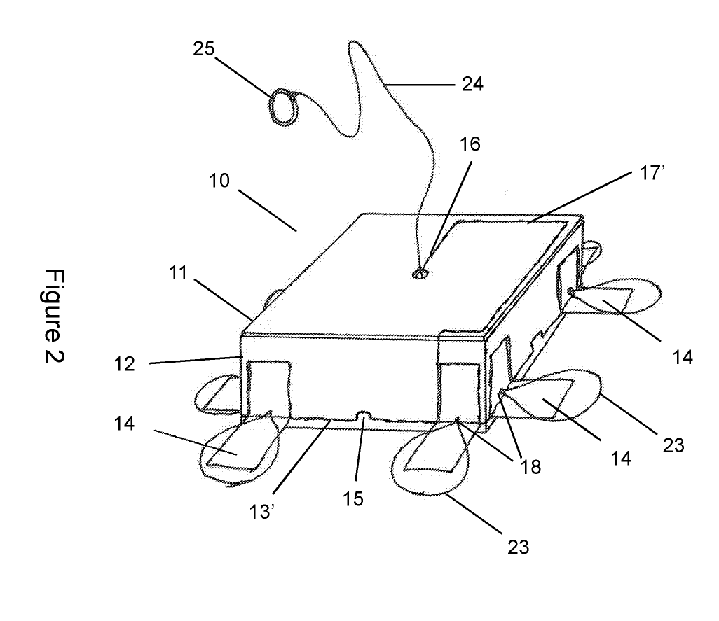

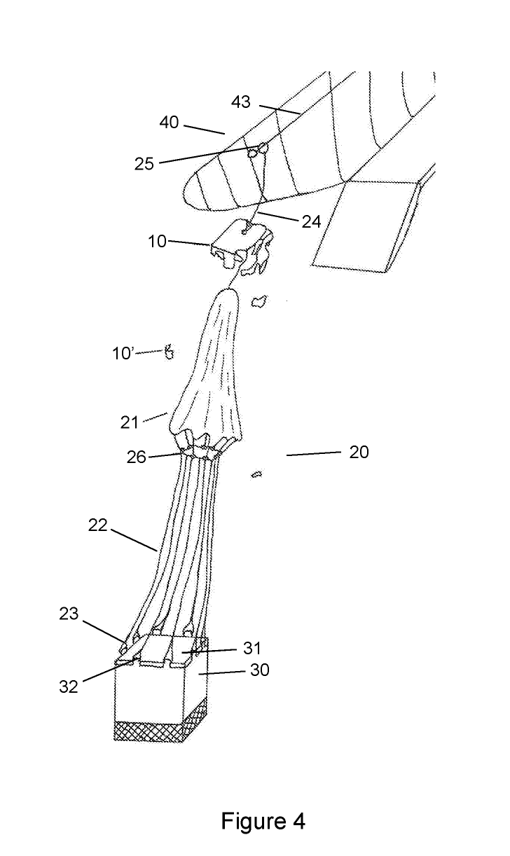

The parachute 20 is contained within the inner box 11. In this embodiment, the parachute 20 comprises a canopy 21, eight shroud lines 22 (see FIGS. 2 and 4) and a static line 24 (see FIGS. 2 to 4). The ends 23 of each of the eight shroud lines 22 of the parachute 20 extend through apertures 18 in the inner box 11 into the region between the inner box 11 and the outer tray 12. The end 23 of each shroud line 22 may terminate in a clip or hook for attachment to a load 30 and/or may form a loop that attaches to the hooks or clips on the load 30 (as shown in FIG. 3). Each of the ends 23 is releasably secured to the inner surface (i.e. back) of one of tab 14 such that each tab 14 has a single shroud line 22 attached thereto. In this embodiment, this is achieved by using a glue that forms a readily frangible connection to releaseably hold the end 23 of the each shroud line 22 to a respective tab 14. However, in alternative embodiments, other means of securing the shroud lines 22 in this position may be employed, such as a clip or other holding means located on the box 11 or tray 12 or through being held between a close fit connection between the inner box 11 and the outer tray 12.

By having the ends 23 of the shroud lines 22 located behind the tabs 14, a user can easily and quickly remove or fold down each of these tabs 14 to expose the ends 23 of the shroud lines 22 (see FIG. 2) and subsequently attach the lines 22 to attachment points 32 on the cargo or load 30. As will be appreciated, this arrangement allows for the straightforward attachment of the parachute 20 to the load 30, without having to remove the parachute 20 from the packaging 10 and risk unfolding the parachute 20, which may result in the parachute 20 failing to open, or in the tangling of the shroud lines 22, for example.

The opening of the tabs 14 in this embodiment is facilitated by a line of weakness 13 that extends around the outside of the outer tray 11. In particular, all of the tabs 14 of the packaging 10 are defined by a single line of weakness (e.g. perforation) 13 that extends around the outer tray 12. In other words, the tabs 14 are formed in the wall of the outer tray 12 and the line of weakness 13 is shaped such that once the line of weakness 13 is broken, this portion of the wall (i.e. the tabs 14) can be folded down to expose the ends 23 of the shroud lines. FIG. 2 shows a view of the packaging 10 with the ends 23 of the shroud lines 22 exposed.

While multiple line of weakness can be used to define each tab 14 individually, such that each line of weakness can be independently ruptured, it is advantageous to have a single line of rupture as the parachute static line 24 can be used to open the tabs 14 prior to attaching the load 30. In this embodiment, the static line 24, which is attached to the canopy 21 of the parachute 20, extends from the inner box 11 through an aperture in the inner box 11 (not shown) into the region between the inner box 11 and the outer tray 12 and is wrapped around the inner box 11. In other words, there is a single loop of the static line 24 extending around the inner box 11, said loop of static line 24 being concealed in the region between the inner box 11 and the outer tray 12. To enable a user to access the static line 24, the tip of the static line 24 extends out of the outer tray 12. The loop of static line 24 extending around the inner box 11 can be secured to the inner surface of the outer tray 12 such that the static line 24 traces or follows the line of weakness along the inner surface of the outer tray 12 and can terminate with the end of the static line 24 extending through an aperture (not shown) in the outer tray 12. In this embodiment, the static line 24 terminates in a ring 25, which can be seen on the outside of the packaging 10.

Accordingly, when a user pulls the ring 25, the static line 24 is pulled from its position between the inner box 11 and the outer tray 12, through the line of weakness 13 such that the line of weakness 13 in that region is ruptured. As the user continues to pull the ring 25 along the path of the line of weakness 13, the static line 24 continues to rupture the line of weakness 13 until it has been ruptured along the entire circumference of the outer tray 12.

In the embodiment of FIG. 1, the aperture in the inner box 12 through which the static line 24 extends is located directly behind the original location of ring 25 and a line of weakness 17 on the inner box 13 extends from this point, along the path indicated in FIG. 1 until it meets the opening 16. This arrangement allows the static line 24 to continue along the lines of weakness 13, 17 until the exposed (upper) face of the inner box 11 is partially opened and the line of weakness 17 is fully ruptured (17′). As will be appreciated, this will facilitate extraction of the parachute 20 from the packaging 10.

The outer tray 12 further comprises a secondary tab 15, which is releaseably connected to the inner box 11 using a frangible glue. The secondary tab 15 increases the structural integrity of the packaging 10 by providing a releasable connection between the inner box 11 and the outer tray 12, until the parachute is deployed, when the releasable connection is broken.

As can be seen in FIG. 2, once the line of weakness 13 has been fully ruptured (13′), the static line 24 of the parachute 20 extends outwardly of the packaging 10 and can be attached to a static line clip rail 43 (see FIG. 3) to enable deployment of the parachute 20 when the load 30 and parachute 20 are released from the aircraft 40.

Accordingly, in use, a user could first place the packaging 10 of the present embodiment on top of the load 30 that is going to be delivered by aerial delivery. The ring 25 can then be pulled to break the line of weakness 13 about the outer tray 12 using the static line 24. This opens tabs 14 and exposes the ends 23 of the shroud lines of the parachute inside packaging 10. The user can then either continue to pull the static line 24 such that the line of weakness 17 across the exposed face of the inner box 11 is ruptured or can first attach the ends 23 of the shroud lines to an attachment means 32 on the load 30. In some instances, it would be advantageous to refrain from rupturing the line of weakness 17 across the upper face of inner box 11 until the parachute 20 has been secured to the load 30 via the ends 23 of the shroud lines 24 to avoid the structural integrity of the packaging 10 being compromised while repositioning or movement is still required or possible. In any event, regardless of the order in which the user attaches the ends 23 of the shroud lines to the load 30 and ruptures the lines of weakness 17 on the inner box 11, the parachute 20 will still be held in the packaging 10 and will be secured to the load 30 via attachment means 32.

In the embodiment depicted in FIG. 3, the attachment means 32 is formed on a reinforced attachment plate 31 that forms an upper portion of load 30. The skilled person will appreciate, however, that many forms of attachment mechanism can be used to secure the shroud lines of a parachute to a load 30. The securing of the parachute to the load 30 can take place either before the load 30 is loaded onto the aeroplane 40, or once the packaging is on the aircraft, or a combination thereof. For instance, the ends 23 of the shroud lines 22 may be exposed but the line of weakness 17 on the upper face of the inner box 11 may remain intact when the load 30 is put into the hold 41 of an aeroplane 40.

FIG. 3 shows the parachute 20 contained within packaging 10 and secured to the load 30 inside the hold 41 of an aeroplane 40, with the rear door 42 of the aeroplane 40 opened. As will be seen, the static line 24 has been extended by breaking line of weakness 17 in the upper face of the inner box 11 of packaging 10 and the ring 25 has been attached to the static line clip rail 43 of the aeroplane 40. The load 30, including the parachute and the packaging 10 can then be released from the aeroplane 40.

FIG. 4 illustrates the deployment of the parachute 20 from the packaging 10. The deployment is using the well-known method of static line deployment. This consists of a static line 24 that is attached to a static line clip rail 43 inside an aeroplane 40 via a ring or clip 25. As the load 30 is released from the rear of the aeroplane 40 and begins to fall, the static line 24 pulls the parachute 20 out of the packaging 10 such that the canopy 21 of the parachute 20 deploys. A slider 26, or other means of controlling the speed of deployment of the parachute 20, may be incorporated into the parachute 20 and a pilot chute (not shown) may be used. In this embodiment, the packaging 10 is torn apart or opened (and the releasable connection between the secondary tab 15 and the inner box 11 is broken) as the static line 24 pulls the parachute 20 out of the packaging 10. This is due to a combination of the force applied to the relatively weak structure of the cardboard inner box 11 and a further line of weakness along the join between the base (i.e. the large face that is in contact with the outer tray 12, opposite the exposed face) of the inner box 11 and the perpendicular associated smaller sides of the box 11. However, it will be appreciated that either can be sufficient on their own to allow rupture of the packaging 10 and therefore exposure of the parachute. The rupture of the packaging 10 as the parachute 20 is deployed will result in the formation of numerous fragments of the packaging 20. As will be appreciated, the location of the line of weakness on the inner box 11 will alter the way in which the packaging 10 fragments form. In this embodiment, (with the line of weakness along the join of the base of the inner box 12 to the side wall portions), it will be appreciated that the rupture will result in the outer tray 12 and the lower portions of the inner box 11 being located between the parachute 20 and the load 30. In this embodiment, these lower portions (including the outer tray 12) of packaging 10 will disintegrate into small enough pieces 10′ during the extraction that it simply slowly falls to the ground, since it may be formed of cardboard (as it is in this embodiment). This may be facilitated with additional lines of weakness. In another embodiment, the outer tray 12 may comprise a further line of weakness along its base such that when the parachute is released, the entire packaging is retained by the static line. Alternatively, the lower tray 12 may be secured to the top of the load, so as to avoid any risk of the debris interfering with the parachute or shroud lines. For instance, the outer tray 12 may have a cover (not shown) on the load facing surface that can be removed to expose a surface capable of adhering to the load, such as a surface coated with glue. During deployment, the upper portions of the inner box 11 may remain attached to the static line 24 and thus the aircraft. In a preferred embodiment, the upper portions of the box will simply fall away as the parachute is deployed as this will reduce the drag experienced by the aircraft, which can be particularly problematic if numerous loads have been deployed. This may be achieved by using a deliberate weakness on the inner box 11.

After the parachute 20 has been deployed, the static line 24, which will contain some form of a deliberate weakness (such as Velcro or a break line), will disconnect from the parachute 20. In one embodiment, this weakness can be positioned such that the packaging 10 does not remain attached to the aircraft 40.

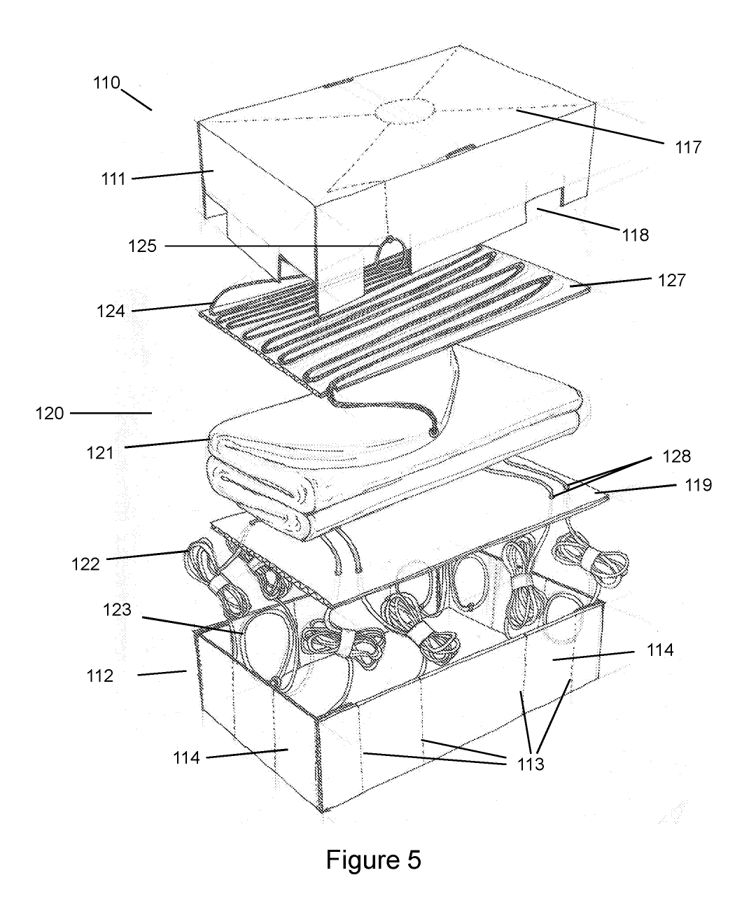

An exploded view of another embodiment of the invention is shown in FIG. 5. The packaging 110 of this embodiment houses a parachute 120, the parachute 120 comprising a canopy 121, shroud lines 122 having ends 123 and a static line 124, which terminates in a ring 125. The parachute 120 is folded and stored within an upper lid 111 and a lower tray 112 of the packaging 110 and is arranged such that it can be deployed directly from the packaging 120. In this embodiment, the packaging 110 comprises, or can consist essentially of corrugated cardboard. In other embodiments, the packaging 110 may comprise, or can consist essentially of, an in-expensive biodegradable and/or recyclable plastic, for example a Polylactic acid (PLA). PLA has the advantages of being relatively cheap, strong and produced using environmentally friendly resources, while being clean burning.

The lower tray 112 of the packaging 110 comprises a number of perforations 113 running from the upper edge of the side panels to the lower edge of the side panels. In this embodiment, there are sixteen perforations 113 in total—four on each side panel. The sixteen perforations 113 define eight tabs 114. As with the embodiment of FIGS. 1 to 4, the perforations 113 can be ruptured so as to enable the tabs 114 to be opened and to expose the ends 123 of the shroud lines 122, which are located and held in a predetermined position behind the tabs 113. In this embodiment, each of the shroud lines 122 extend from the folded canopy 121, through apertures 128 in a holding tray 119 with the end 123 secured to a tab 114 using an adhesive. Any slack in a shroud line 122 is gathered and held to avoid the risk of tangling. The holding tray 119 serves to further separate and secure the shroud lines 122. In another embodiment, if the holding tray 119 is sufficiently strengthened (for example, with additional cardboard layers or reinforced with biodegradable plastic), the holding tray 119 may also serve as a slider for slowing the rate of opening during deployment of the parachute 120.

The perforations 113 in this embodiment may be ruptured by simply pulling on the upper edge of the tab 114. In other embodiments, pull-tabs may be present on the tabs 114 or there may be holes in the tabs 114 to allow the user to grip the tabs 114 and therefore assist the rupturing of the perforations 113. The user can then attach the ends 123 of the shroud lines 122 to the cargo.

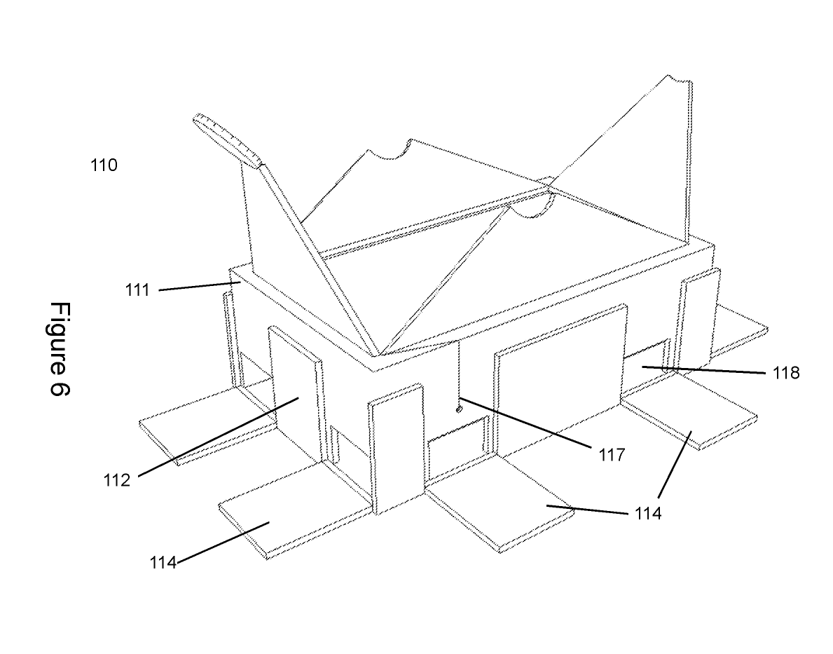

The upper lid 111 of the packaging 110 serves to enclose and contain the parachute 120 in the lower tray 112. The lid 111 comprises apertures or slots 118 through which the shroud lines 122 extend (i.e. from the parachute 120 to the tabs 114) and a number of lines of weakness 117 that are provided to assist with the extraction of the parachute 120. FIG. 6 shows the packaging of FIG. 5 with the parachute 120 omitted and with all of the lines of weakness 113, 117 broken.

The end of static line 124 comprises a ring 125, which is used to attach the parachute 120 to the static line clip rail of an aircraft and is initially attached to the upper lid 111 at the start of one of the lines of perforation 117 such that the user can access it. After the parachute 120 has been secured to the load to be delivered via the ends 123 of the shroud lines 122, the static line 124 can be used to rupture, or assist the user in rupturing, the lines of weakness 117. It will be appreciated that in alternative embodiments, the end of the static line 124 may be contained within the packaging 110 and not used to perforate the lines of weakness 117 or presented on the outside of the packaging 110 but not used to perforate the lines of weakness 117. Other means of assisting in perforating the lines 117 may be employed, such as a dedicated ripcord. This may be used instead of or in addition to the static line 124. In other alternative embodiments, a parachute having an alternative or modified extraction system may be used and hence there may be no static line. These embodiments may also utilise other means of assisting perforation. Once the weaknesses 117 have been ruptured, the static line 124 is attached to a static line rail clip (not shown) via the ring 125. The cargo can then be released from the aircraft. Alternatively, all of the lines of weakness 117 could remain intact (unbroken) until the cargo is released, in which case the action of the static line 124 tensing would extract the parachute 120 from the packaging 110, with the lines of weakness 117 facilitating the extraction by reducing the force required to extract the parachute 120.

In this embodiment, and the embodiment of FIGS. 1 to 4, it would be advantageous if the force required to extract the parachute 20, 120 from the packaging through the perforations 17, 117 was less than the force required to separate the upper lid 111 or inner box 11 from the lower tray 12, 112. In this case, the majority or all (depending on how much debris is formed during extraction of the parachute) of the packaging 10, 110 would fall with the load, particularly if the packaging 10, 110 was secured to the load, for example by an adhesive. This would reduce the amount of debris falling and/or the amount of debris retained on the static line. As will be seen in FIG. 5, the packaging 110 further comprises an upper tray 127. The upper tray 127 is provided as a means of preventing the static line 124 from becoming tangled with the parachute 120 and preventing the parachute 120 from deploying correctly. The static line 124 is initially attached to the upper tray 127 using a frangible adhesive, which allows the static line 124 to be drawn out freely but does not allow the static line 124 to be loose in the packaging 110 before the packaging 110 is opened. This also prevents the static line 124 from becoming tangled with any other part of the opening mechanism. As will be appreciated, when cargo is released from an aircraft a number of forces are exerted on the components of the parachute 120. These include a force that arises when the static line tenses and pulls the parachute 120 out of the packaging 110 and a force applied to the shroud lines when the parachute inflates and the descent of the cargo is slowed.

Many other force mitigation concepts are widely available and also could be employed, including the use of the lower tray 119 as a slider, as discussed above. In further embodiments, the shroud lines may also employ force mitigation concepts. For example, at least a portion of one shroud lines can be releaseably secured in a gathered formation such that when tension is applied the shroud line is lengthened.

Although the embodiments of FIGS. 1 to 6 comprise an inner box 11 or inner lid 111 contained within an outer tray 12, 112, it will be appreciated that the combination of the inner box 11/inner lid 111 and the outer tray 12, 112 could instead be replaced by a single box. For example, the box could have both the means for accessing the shroud lines and the weaknesses for releasing the parachute.

In addition, while the configuration of one shroud line being located behind each tab is present in the embodiments of FIGS. 1 to 6, it will be appreciated that each tab may conceal more than one shroud line.

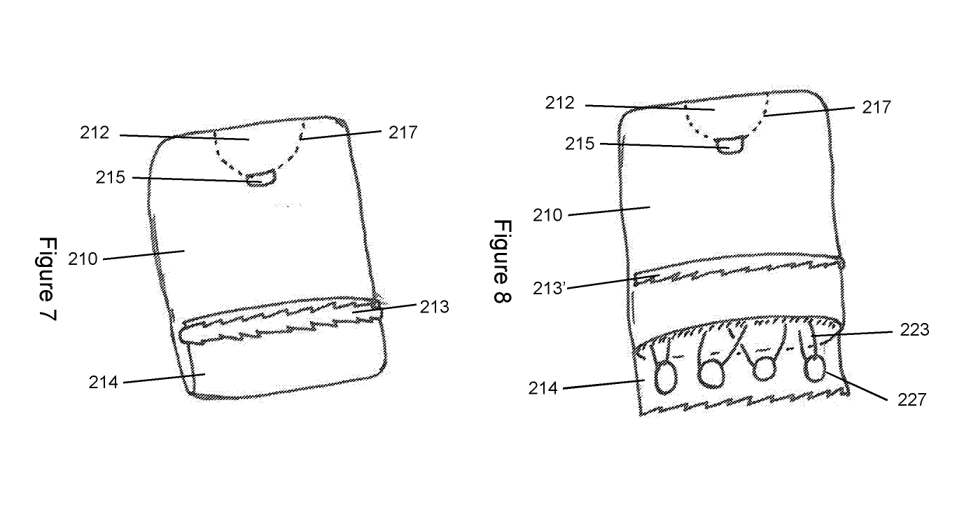

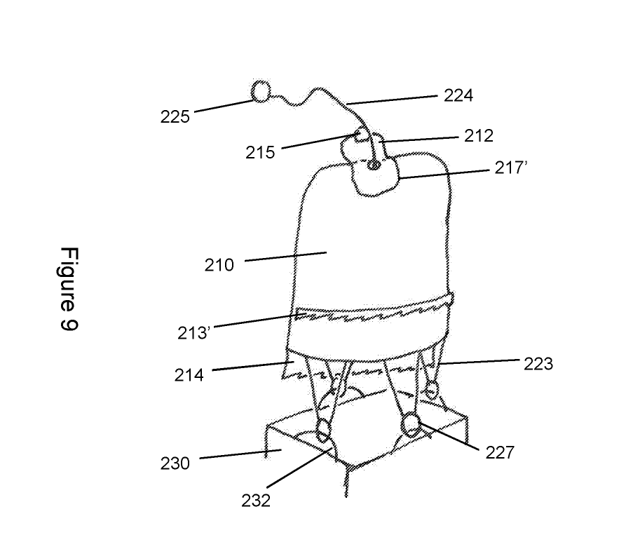

Another embodiment of the present invention is shown in FIGS. 7 to 10. In this embodiment, there is provided a bag 210. In this embodiment the bag is formed of paper. However, in other embodiments the bag may be formed (entirely or partially) of other disposable materials, for example woven Polylactic Acid. The bag contains parachute 220, which comprises a canopy 221; shroud lines 222 having ends 223 connected to clips 227; and a static line 224, which terminates in a clip 225. The parachute 220 is held in a position in the bag, such that the ends of the shroud lines 223 are held in a predetermined position at the base of the bag 210 (the base referring to the end terminating in flap 214). Within the bag, the shroud lines may be held in position by any known means, such as by an adhesive, a clip, a strap or the ends may be contained within flap 214 and as such are held in a fixed position.

The bag 210 is used in a similar fashion to the embodiments of FIGS. 1 to 6. In particular, the bag has a tear strip or frangible seal 213, which holds the folded over flap 214 in a closed orientation. Of course, any form of closing mechanism could be used, such as a zip, strap or perforations. When the seal 213 is broken (213′) the ends 223 of the shroud lines 222 and clips 227 are exposed. From here the shroud lines 222 can be attached to a load 230 (see FIG. 9) via clips 230 and the corresponding attachment mechanism 232 on the load 230. In this case, the attachment mechanism 232 is a loop for receiving clips 227.

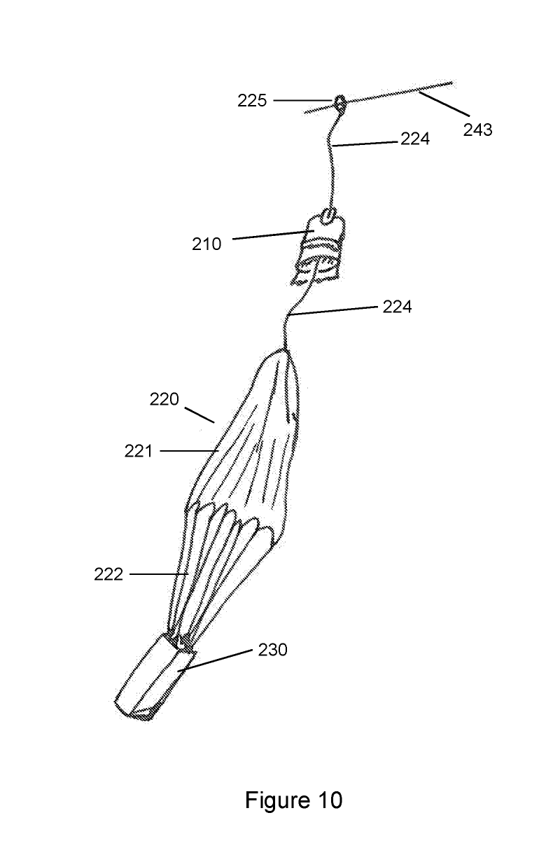

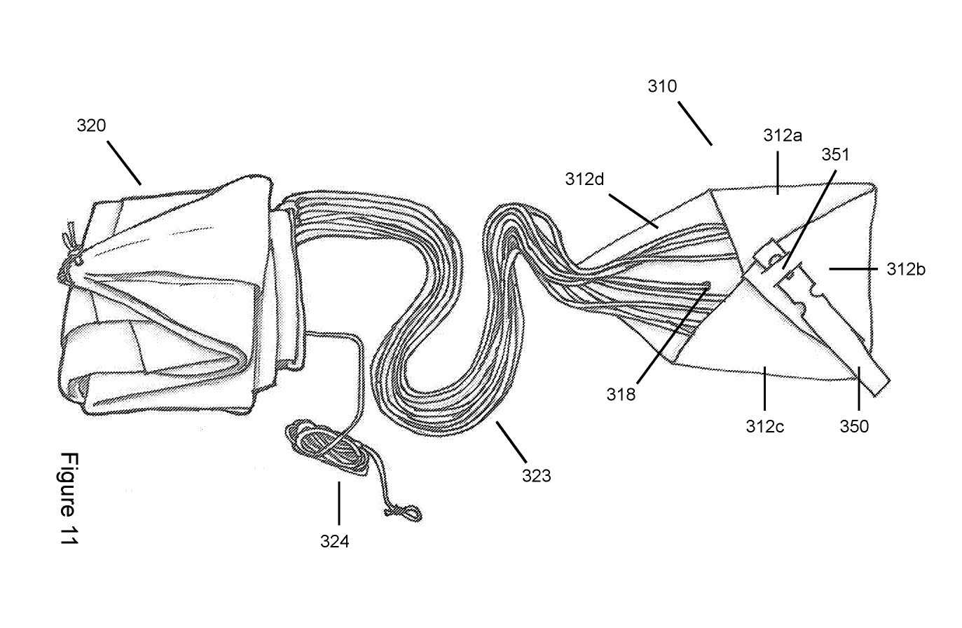

The bag 210 has a further flap 212, which comprises tab 215. The flap 212 is defined by a perforation 217, which can be ruptured by pulling tab 215. Held behind the flap 212 is the static line 224 and ring 225. In this embodiment, this is achieved through the use of an inner layer of the bag, which has an aperture therethrough; however, it will be appreciated that the static line 224 may be held in position by any means. By rupturing the perforation 217 (forming 217′), the static line 224 and ring 225 of the parachute is exposed, which can then be attached to the static line clip rail 243 of an aircraft (see FIG. 10). The load 230 and the bag 210 can then be released from the aircraft. As with previous embodiments, the bag 210 may be retained on the static line, or may preferably descend with the packaging or separately as debris. As the bag 210 is formed of biodegradable material (e.g. paper), there is a relatively low risk of damage and low environmental impact.

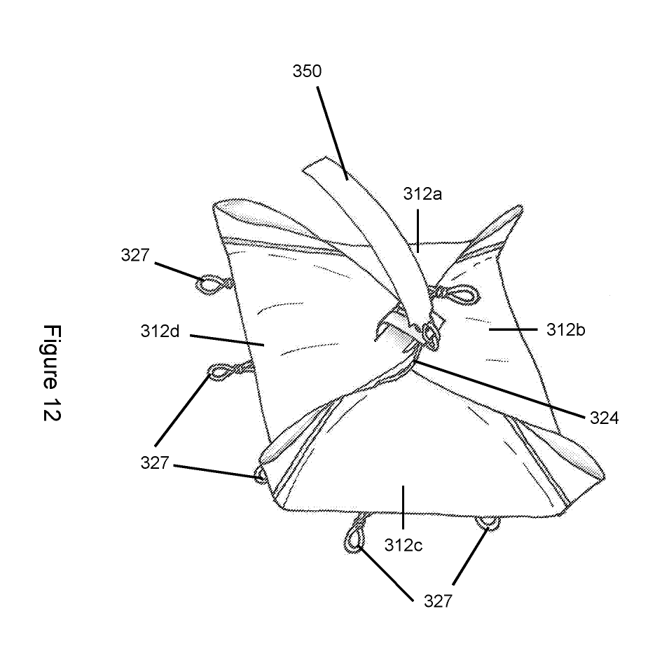

A further embodiment of the invention is shown in FIGS. 11 and 12. FIG. 11 shows a partially unpacked view of a packaging 310. The packaging 310 is formed of a sheet of material, such as cotton or paper, having a number of flaps 312a, 312b, 312c, 312d folded over to form an enclosed packaging 310. The packaging 310 comprises a number of apertures 318 (only one aperture 318 can be seen in FIG. 11) through which the shroud lines 323 of the parachute 320 extend. The apertures 318 maintain the shroud lines 323 in a position which prevents them from becoming tangled with one another, or with other parts of the parachute 320 and/or packaging 310 and allows the loops 327 for attaching the shroud lines 323 to a load to be held in a position in which they can easily be accessed and attached to the load without removing the parachute 320 from the packaging 310.

As shown in FIG. 12, in folded and packaged packaging 310, the parachute 320 is also received within the packaging 310 and the packaging 310 is held closed by a closing clip 350, which extends through slits 351 in each of the flaps 312a, 312b, 312c, 312d. The corners of the packaging 310 in this embodiment are also are heat-sealed so as to close the packaging 310. The static line 324 of the parachute 320 is also held by the closing clip 350, so as to be easily accessible. Furthermore, the static line 324 is tied to the closing clip 350 so that as it comes under tension it pulls the closing clip 350 through the flaps 312a, 312b, 312c, 312d of the packaging 310 and opens the packaging 310 up.

As with the previous embodiments, the static line 324 can be clipped to a static line rail inside an aircraft, and release of a payload comprising the packaging 310 from an aircraft results in the static line 324 tearing the packaging 310 open as the payload drops away from the aircraft. This extracts the parachute 320 and shroud lines 323 from the packaging 310, thereby allowing the parachute 310 to deploy.

In the embodiments described above, the shroud lines are typically held in a predetermined position behind a tab that can be accessed by perforating a line of weakness. However, it will be appreciated that there are numerous means by which the shroud lines could be held in a predetermined position and/or concealed by the packaging. For instance, in some embodiments, there may be an aperture or window next to or at which the shroud line is held. The user can therefore simply just reach into the window or aperture and withdraw the shroud line from the packaging. In some embodiments, the ends of the shroud lines may be attached to the wall surrounding the window or aperture, or may extend through the window or aperture. In addition, there may be a cover or door across the window/aperture to conceal or contain the shroud lines. This may, for example, be removed by tearing off, sliding across or any other means. In some embodiments there may be pockets in which the shroud lines, particularly the ends of the shroud lines, are held.

In the above embodiments, the parachute 20, 120 may be formed of a biodegradable material. By biodegradable, it is meant that materials can be decomposed by microorganisms, in particular by bacteria. The invention in this aspect provides an inexpensive parachute 20, 120 having a low environmental impact. In another embodiment the parachute 20, 120 consists essentially of a biodegradable material, for example the parachute 20, 120 (including the canopy 21, 121 and/or the shroud lines 22, 122) is almost entirely formed from a biodegradable material, but may contain minor quantities of other materials. In one embodiment the biodegradable material is paper or another woodpulp derivative. Thus, in some embodiments both the parachute 20, 120 and the packaging 10, 110 are comprised of materials that can be safely burned, recycled or are biodegradable. Moreover, a parachute 20, 120 comprising a material made from woodpulp can be designed to be single-use without being expensive, an inefficient use of resources or harmful to the environment.

Additional features may also be present in the above embodiments, such as safety clip to prevent the accidental opening of the packaging using the pull-through lines (i.e. the static line or a separate ripcord).

It will also be appreciated that if line of weakness are used, they may be only be partially ruptured along their length to expose the shroud lines or to facilitate the extraction of the parachute.

In embodiments, including those of FIGS. 1 to 12 the packaging may comprise, or consist essentially of, a biodegradable material such as paper, cardboard or any other woodpulp material; cotton; biodegradable plastic (e.g. Polylactic acid or cellulose); or any other biodegradable material. By biodegradable, it is meant that materials can be decomposed by microorganisms, in particular by bacteria. The invention in this aspect provides an inexpensive and lightweight box providing means for containing and protecting a parachute for aerial delivery. PLA has the advantages of being relatively cheap, strong and produced using environmentally friendly resources, while being clean burning. Furthermore, PLA can be woven into textile form to strengthen the packaging. The use of such materials allows the packaging to be recycled, or easily disposed of and thus reduces wastage and environmental impact. Furthermore, the use of inexpensive cardboard and plastic components means that the system is a low cost option for the delivery of goods compared to other aerial delivery methods and while having a low environmental impact. In some embodiments, the packaging can be burned, recycled or left to biodegrade.

In another embodiment, the packaging is covered with a waterproofing material to protect the packaging and the parachute therein. In another embodiment, the waterproofing material is a wax, in particular a clean-burning wax or a polymer coating of nano-scale thickness, allowing the packaging to be safely burned. The term “nano-scale thickness” means a thickness of 1 nm to 10000 nm, preferably 1 nm to 1000 nm thick, more preferably 1 nm to 500 nm thick. For example, the polymer coating may be a hydrophobic polymer coating such as ethylcellulose.

While the embodiments of the invention depicted in FIGS. 1 to 12 are intended for use with a static line deployment method, other methods of parachute deployment can also be used in conjunction with the present invention, including the use of a drogue-chute instead of or in addition to a static line or by using a parachute extraction method.

Other variations to the disclosed embodiments can be understood and effected by those skilled in the art in practicing the claimed invention, from a study of the drawings, the disclosure, and the appended claims. For example, in the examples above:

a parachute can be of any shape including round, a square, conical, hexagonal, triangular or regular or tapered ram-air parachutes or any other shape of parachute and it is not limited to a single parachute;

the parachute may have more or less shroud lines, for example there may be 8, 9, 10, 12, 14, 16, 20, 24, 32 or more shroud lines concealed by each tab and there may be more than one shroud line behind each tab;

the shroud lines may comprise any means of attachment, such as a clip mechanism, or may be tied to the load, for example using the shroud lines or using a plastic cable tie; similarly, the load may comprise any means of attaching to the shroud lines;

the parachute may be formed of biodegradeable materials, including a tear-resistant wood pulp derivative material, for example air-laid paper, or polylactic acid (PLA);

the packaging may be used to attach to loads that are delivered using any aircraft, such as aeroplanes, helicopters or unmanned aerial vehicles, for example; and

lines of weakness may include a number of weaknesses such as perforations or portions where the material is thinner than the surrounding material, for instance; perforations may be formed using a variety of techniques and in a variety of materials including puncturing with a tool or pin, formation using laser or by any other means.

In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A parachute arrangement comprising:
a parachute having a canopy, a plurality of shroud lines coupled to the canopy, and a plurality of connectors coupled to the shroud lines for attachment to a load; and
a packaging for the parachute, the packaging comprising an enclosure formed of a web material,
wherein each of the shroud lines and/or connectors is engaged with the enclosure to thereby maintain the connectors in a predetermined arrangement for attachment to the load.

2. The assembly of claim 1, wherein the engagement between the shroud lines and/or the connector and the enclosure comprises an adhesive attachment.

3. The assembly of claim 1, wherein the engagement between the shroud lines and/or the connector and the enclosure comprises an mechanical connection, such as stitching.

4. The assembly of claim 1, wherein the engagement between the shroud lines and/or the connector and the enclosure comprises the connector, and optionally the shroud lines, extending through an aperture formed in the enclosure.

5. The assembly of claim 1, wherein the enclosure is adapted to conceal the connectors; and
the packaging further comprises means for tearing the web material of the enclosure in a predetermined pattern to expose the connectors for attachment to the load.

6. The assembly of claim 5, wherein the predetermined pattern defines a plurality of flaps of web material, each flap for exposing a respective different connector.

7. The assembly of claim 6, wherein each shroud line and/or connector is engaged with the inside surface of one of the plurality of flaps.

8. The assembly of claim 5, wherein the means for tearing comprises a linear weakness in the web material, such as a line of perforations.

9. The assembly of claim 1, wherein the parachute further comprises a deployment line coupled to the canopy, optionally provided with a drogue parachute.

10. The assembly of claim 9, wherein the deployment line is engaged with the enclosure to thereby maintain the deployment line spaced-apart from the connectors.

11. The assembly of either claim 8, wherein the means for tearing comprises the deployment line being adapted to tear the web material in the predetermined pattern when it is pulled.

12. The assembly of claim 1, wherein the enclosure is structurally independent of the parachute.

13. The assembly of claim 1, wherein the enclosure further comprises additional weaknesses in the web material adapted to facilitate extraction of the parachute from the enclosure during deployment.

14. The assembly of claim 1, wherein the web material is adapted to tear upon deployment of the parachute in static conditions with a 5 kg load.

15. The assembly of claim 1, wherein the connectors are extended from the shroud lines, and optionally comprise loops.

16. The packaging of claim 1, wherein the enclosure comprises an outer housing and an inner housing housed within the outer housing; and
wherein the canopy of the parachute is contained within the inner housing and the connectors, and optionally the shroud lines, of the parachute extend from the inner housing into the outer housing.

17. The packaging of claim 1, wherein the packaging is formed of a biodegradable material, optionally the packaging consists essential of a biodegradable material.

18. The packaging of claim 1, wherein the predetermined arrangement is a space-apart arrangement.

19. A disposable parachute packaging for a parachute comprising a canopy, a plurality of shroud lines coupled to the canopy, and a plurality of connectors coupled to the shroud lines for attachment to a load, the packaging comprising:
an enclosure formed of a web material,
wherein the enclosure is adapted to engage each of the shroud lines and/or connectors to thereby maintain the connectors in a spaced-apart arrangement for attachment to the load.
